(19) United States
(12) Patent Application Publication
(10) Pub. No.: US 2026/0368772 A1
(43) Pub. Date: Nov. 19, 2026

(54) METHOD OF ESTABLISHING AND MONITORING A PAYMENT RANKING METRIC FOR A BUSINESS ENTITY

(71) Applicants: Christopher James Simeniuk, Alix (CA); Leah Simeniuk, Alix (CA)

(72) Inventors: Christopher James Simeniuk, Alix (CA); Leah Simeniuk, Alix (CA)

(21) Appl. No.: 19/207,292

(22) Filed: May 13, 2025

(51) Int. Cl. G06Q 30/0217; G06Q 20/14

(52) U.S. Cl. CPC G06Q 30/0218; G06Q 20/14

(57) ABSTRACT

A method of establishing and monitoring an entity payment ranking that utilizes data from users engaged in financial transactions with a company wherein the data is employed to derive a business payment ranking metric as a leading indicator of payment behavior and/or habits of a company. The method is operated utilizing a software application providing a graphical interface for use thereof. A user will enter a first metric, calendar days to pay invoice and a second metric, calendars days for invoice approval, to calculate a business payment ranking metric and provides insight into a company's payment behavior. The data metrics of the companies tracked with the software are provided to users in three different types of reports. Users of the method are provided credits for each entry about a company wherein those credits are redeemed with the operator of the method to purchase a detailed report on a desired company.

### FIELD OF THE INVENTION

The present invention relates generally to business financial tools, more specifically but not by way of limitation, a method that provides a metric of payment habits for entities wherein the payment habits are documented by businesses that conduct interactions with the entities.

### BACKGROUND

Cash flow is the lifeblood of any business, determining its ability to meet financial obligations, invest in growth, and maintain operational stability. One of the most significant challenges that businesses face is dealing with slow-paying or defaulting entities, which can create financial strain and disrupt the company's financial health. Additionally, managing entities with poor credit is crucial to mitigating risks associated with delayed or defaulted payments. Slow-paying and defaulting entities can severely impact a business's liquidity by delaying the availability of funds needed for daily operations. When payments are not received on time, businesses may struggle to pay suppliers, employees, and other operational expenses, which can lead to cash shortages. To compensate for delayed payments, businesses may need to rely on external financing such as loans or credit lines. This results in additional interest costs, reducing profitability and straining financial resources. High dependency on borrowed funds can also increase long-term financial risks.

Cash flow disruptions caused by slow payments can hinder a company's ability to reinvest in expansion opportunities, such as purchasing new equipment, hiring staff, or launching new products. Businesses with unstable cash flow may find it difficult to secure investor confidence or funding for growth initiatives. Businesses depend on timely payments to suppliers to maintain healthy relationships and ensure the continuous supply of goods and services. When cash flow is disrupted, companies may face difficulties in meeting supplier payment deadlines, potentially leading to strained relationships, supply chain disruptions, or increased costs due to stricter credit terms. Managing late payments requires additional administrative effort, including sending payment reminders, negotiating with entities, and engaging in collection efforts. These activities consume valuable time and resources that could be better spent on revenue-generating activities.

Conducting thorough credit checks on entities before extending credit is essential to identifying potential risks. Businesses should review credit reports, payment history, and financial stability indicators to assess the likelihood of timely payments. Establishing and enforcing strict credit policies helps businesses manage risks associated with poor credit entities. Defining clear payment terms, including due dates, penalties for late payments, and credit limits, ensures that entities understand their obligations and reduces the risk of delayed payments. Offering discounts or incentives for early payments can encourage entities to settle their invoices promptly. This approach not only improves cash flow but also fosters stronger customer relationships by rewarding timely payments. Businesses need additional financial tools to provide additional security and minimize the chances of payment defaults.

Accordingly, there is a need for a software application that facilitates a method that provides an objective measure serving to provide a metric for payment habits of entities wherein the payment habits are documented by businesses that conduct interactions with the entities.

### SUMMARY OF THE INVENTION

It is the object of the present invention to provide a method operable to provide a metric of an entity's payment habits wherein the present invention includes the step of registering a multitude of companies that are incented to input transactional payment information of their entities.

Another object of the present invention is to provide a software application that is configured to facilitate a method of monitoring a payment ranking score of an entity wherein the present invention utilizes a first metric and a second metric to calculate a ranking of an entity company.

A further object of the present invention is to provide a method operable to provide a metric of an entity's payment habits wherein the present invention includes a step of calculating a business payment ranking metric based on the data received for the first metric and second metric.

Yet a further object of the present invention is to provide a software application that is configured to facilitate a method of monitoring a payment ranking score of an entity wherein the first metric provides a measure of the number of calendar days to pay an invoice.

Still another object of the present invention is to provide a method operable to provide a metric of an entity's payment habits wherein the second metric is a measure of the amount of time a entity consumes to approve an invoice.

An additional object of the present invention is to provide a software application that is configured to facilitate a method of monitoring a payment ranking score of an entity wherein a user of the present invention accumulates credits for inputting data.

Yet a further object of the present invention is to provide a method operable to provide a metric of an entity's payment habits wherein the present invention inhibits inactive users to access current data pertaining to entities.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of an exemplary dashboard of the present invention; and

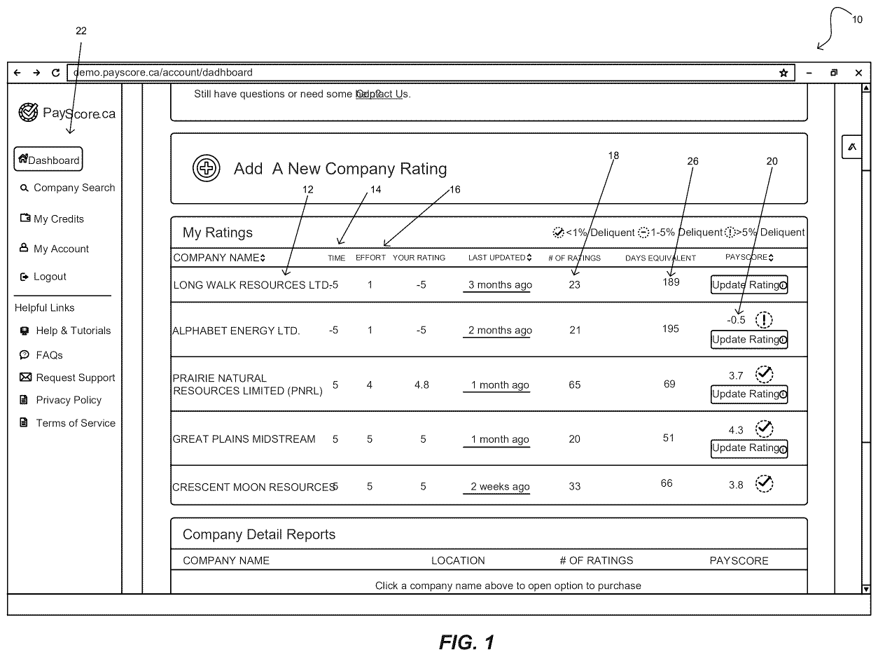

FIG. 2 is diagrammatic view of an exemplary analytics report of entities provided by the present invention; and

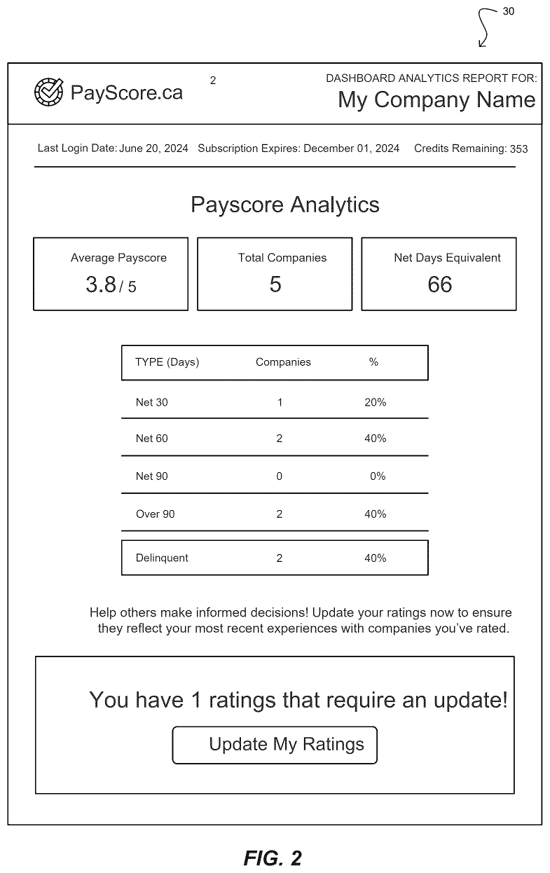

FIG. 3 is an exemplary outline of the process of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a method of establishing and monitoring an entity payment ranking 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the method of establishing and monitoring a entity payment ranking 100, in particular the process thereof and exemplary screenshots of the software application providing operation of the present invention is illustrated therein. It should be understood within the scope of the present invention that the steps of the method outlined herein are exemplary and order thereof could be executed in alternate patterns and further some of the steps could be eliminated. The method of establishing and monitoring a entity payment ranking 100 produces a business payment ranking metric which is a proprietary rating that provides a leading indicator of a entity's payment habits. The determination of the business payment ranking metric and calculation thereof is further discussed herein.

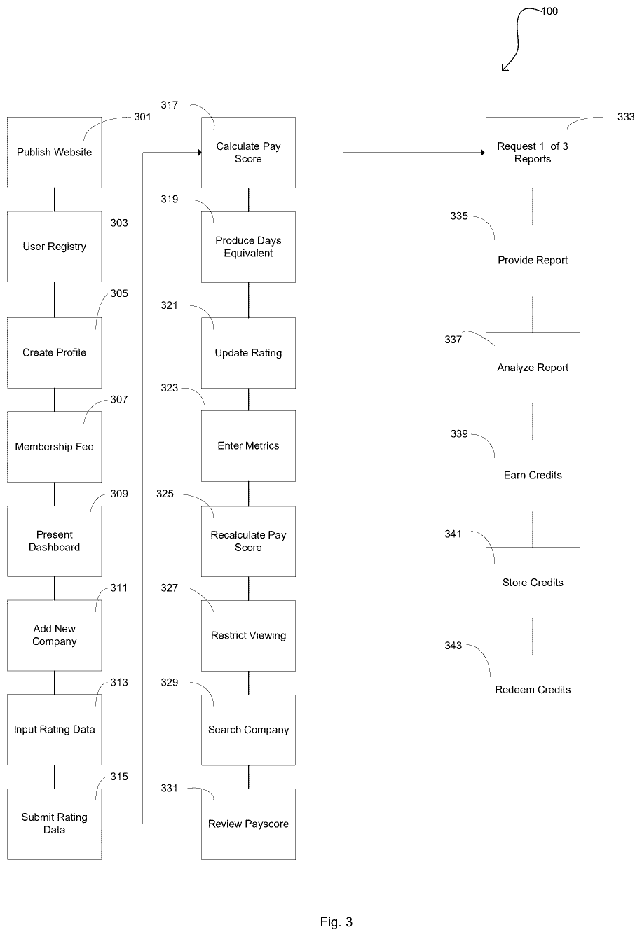

Referring now in particular to FIG. 3 submitted as a part hereof, in step 301, the operator of the method of establishing and monitoring a entity payment ranking 100 publishes the website providing a graphical interface to utilize the software application of the present invention. It should be understood within the scope of the present invention that operation thereof could be implemented via conventional computing devices as well as a software application on a smartphone or other mobile computing devices. Step 303, a user will login to the software application of the present invention and register as a user. In step 305, during user registration, the user will enter requested parameters to create a user profile. It should be understood within the scope of the present invention that the parameters could be but are not limited to entity name, user information and industry information.

Step 307, if desired the operator of the method of establishing and monitoring a entity payment ranking 100 could collect a user fee from the registering user. It should be understood that collection of a user fee is optional and alternate fee collections are further discussed herein. In step 309, the user is presented with a dashboard 10 wherein the dashboard 10 provides a graphical interface with the software application of the present invention. The dashboard 10 displays parameters such as but not limited to entity name 12, invoice rating 14, effort rating 16, rating quantity 18 and business payment ranking metric rating 20. The dashboard 10 further provides a navigation menu 22 that provides various icons for users to operate the method of establishing and monitoring a entity payment ranking 100. In step 311, the user will initiate the process to enter a new company and data regarding their payment experience therewith. Step 313, during the process of adding a new company and entering payment data, the software application will prompt the user to input two metrics for rating data. A first metric is the measure in days of how long the company took to pay an invoice in calendar days. The second metric input by the user is a measure of time in days or weeks in which the user recorded how long invoice approval took inside the new company being added. By way of example but not limitation, if an invoice was submitted to the new company by the user and the new company took four weeks to approve the invoice prior to sending to accounts payable for payment, the four weeks is recorded as the second metric.

In step 315, subsequent entry of the first metric and second metric the user will submit the rating data. Step 317, the software application of the present invention will calculate the business payment ranking metric, which is the average of the first metric and second metric as derived from a scale of one to five. A scale is utilized to extrapolate a calendar day into the one to five ranking. By way of example but not limitation, a calendar term of thirty days or less is assigned a five, which in the method of establishing and monitoring a entity payment ranking 100 is the highest ranking and a positive indicator of payment history. In a preferred embodiment of the present invention, every additional seven days of elapsed time to receive payment would result in a proportional reduction in the business payment ranking metric, wherein the business payment ranking metric is one to five. By way of example but not limitation, the proportional reduction could be equivalent to approximately a quarter of a point of the business payment ranking metric. It should be understood within the scope of the present invention that an alternate scale could be utilized to produce a business payment ranking metric. In step 319, the aforementioned business payment ranking metric and the data input for the calculation thereof is utilized to produce the days equivalent metric 26 so as to provide users another metric regarding payment history. The days equivalent metric 26 is a calendar day term compilation of the first metric and second metric providing users of the method of establishing and monitoring a entity payment ranking 100 a technique to determine total number of days so as to ascertain risk with the ranked company.

In step 321, a user will initiate the procedure to update the rating for a company listed in the software application for an additional interaction with the company regarding an invoice. Step 323, the user will enter the aforementioned first metric and second metric. In step 325, the software application will recalculate the business payment ranking metric utilizing the newly entered first metric and second metric. Step 327, the software application at anytime during utilization thereof can restrict the ability for a user to view the data available in the software application. In a preferred embodiment of the present invention, if a user has not entered payment data for a company in ninety days, the user's ability to view data on companies is restricted until the user resumes entering invoice data for at least one company.

In step 329, a user desiring to identify a business payment ranking metric for a company will search for the company in a provided search field. Step 331, the software application will display a monthly analytics overview 30 that each user gets as a summary on their dashboard for the requested company. In step 333, the user can request a comprehensive report for the company wherein in-depth data on each transaction entered for the company can be viewed. It is contemplated within the scope of the present invention that the comprehensive report can include a multitude of parameters regarding the company. The comprehensive report provides the previous business payment ranking metric on a company. The comprehensive report provides a user data to develop a trending analysis in order to supplement the monthly analytics overview displayed on the dashboard. A comprehensive list report can further be requested wherein the comprehensive list report provides a list of all companies rated in the software of the present invention with an overview of each companies'metrics. Step 335, a detailed report is provided to the requesting user in a suitable format such as but not limited to a spreadsheet. The detailed report provides all the ratings for a defined time period for a company. This detailed report allows a user to trend the history of the company queried. In step 337, the requesting user performs an analysis on the detailed report and utilizes the data to make operational decisions. By way of example but limitation, the user receiving the detailed report on a plurality of companies can leverage the data to determine sales activities or specialized payment terms for the identified companies. Step 339, every time a user enters payment data for a company, the user will earn a credit or a plurality thereof wherein the credit has an equivalent monetary value or replaces an exchange of monetary value between the operator of the present invention and the user. In step 341, the credits earned for each data entry by a user is stored within the software application for subsequent redemption thereof. The credits are utilized by the user to purchase the aforementioned detailed reports on a company or a plurality thereof. Step 343, the user will redeem stored credits to purchase the desired reports. If the user does not have sufficient earned credits, the operator of the method of establishing and monitoring a entity payment ranking 100 collects a monetary fee in lieu of credits to provide the requested report. It should be understood within the scope of the present invention that the earned credits do not have actual monetary value and can only be utilized in exchange for receiving a requested report. The earned credits cannot be utilized by a user for any additional service nor can they be redeemed for actual currency.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method that provides a metric of payment habits for entities wherein the payment habits are documented by businesses that conduct interactions with the entity wherein the method comprises the steps of:
publishing a website, said website being accessible by computing devices, said website operable to provide a graphical interface to a software application configured to run the method;
registering a plurality of users, wherein the plurality of users register to utilize the method,
creating a profile, wherein the plurality of users create a profile, wherein the profile collects data parameters on the plurality of users;
presenting a dashboard to at least one of the plurality of users, wherein the dashboard is a graphical interface on the computing device facilitating operation of the method;
adding a new company, wherein the at least one of the plurality of users adds a new company to a database of the method, wherein the new company is recorded by name in the software application;
inputting rating data, wherein the at least one user inputs rating data for the new company, said rating data consisting of a first metric and second metric;
submitting the rating data, wherein subsequent inputting the rating data the at least one of the plurality of users submits the rating data;
calculating a business payment ranking metric, wherein the software application calculates and provides a business payment ranking metric for the new company, wherein the business payment ranking metric is provided on a scale;
earning at least one credit, wherein the at least one of the plurality of users earns a credit, said credit being earned for inputting rating data;
providing a business payment ranking metric for a plurality of companies, wherein the at least one of the plurality of users is provided through the software application a business payment ranking metric for a plurality of companies;
requesting a comprehensive report, wherein the at least one of the plurality of users requests a comprehensive report on a company in the database of the method;
providing the comprehensive report, said comprehensive report being provided to the at least one of the plurality of users;
requesting a comprehensive list report, said comprehensive list report providing an overview of metrics for all companies on which data is stored in the database;
providing a comprehensive list report;
storing credits, wherein the at least one of the plurality of users storing earned credits for each input of rating data;
redeeming the credits, wherein the at least one of the plurality of users redeems the credits for a detail report.

2. The method that provides a metric of payment habits for entities as recited in claim 1, wherein the first metric is an amount of calendar days taken by a entity to pay an invoice.

3. The method that provides a metric of payment habits for entities as recited in claim 2, wherein the second metric is an amount of calendar days taken by a entity to approve an invoice for payment.

4. The method that provides a metric of payment habits for entities as recited in claim 3, and further including a step of producing a days equivalent measure, wherein the business payment ranking metric is converted to a total calendar day term for the first metric and the second metric.

5. The method that provides a metric of payment habits for entities as recited in claim 4, wherein the business payment ranking metric undergoes a proportional reduction for each lapsed week of time for an entity to pay an invoice.

6. The method that provides a metric of payment habits for entities as recited in claim 5, and further including a step of analyzing a detail report for a purpose of executing an activity, wherein the activity includes an allocation and direction of company personnel.

7. The method that provides a metric of payment habits for entities as recited in claim 6, wherein the business payment ranking metric is calculated utilizing an average of the first metric and second metric.

8. The method that provides a metric of payment habits for entities as recited in claim 7, and further including a step of inputting additional rating data, wherein the at least one user inputs additional rating data for the new company.

9. The method that provides a metric of payment habits for entities as recited in claim 8, and further including a step of recalculating the business payment ranking metric, wherein business payment ranking metric is recalculated utilizing the additional rating data.
